(19) United States
(12) Patent Application Publication
(10) Pub. No.: US 2006/0113119 A1
(43) Pub. Date: Jun. 1, 2006

(54) Method and device for assisting a driver of a vehicle during a parking maneuver

(76) Inventors: Ingo Dudeck, Weinstadt (DE); Eckart Fischer, Stuttgart (DE); Helmut Keller, Stuttgart (DE); Jens Koehnlein, Stuttgart (DE); Jakok Seiler, Stuttgart (DE); Andreas Spieker, Stuttgart (DE); David Ulmer, Stuttgart (DE)

Correspondence Address: FASSE PATENT ATTORNEYS, P.A., P.O. BOX 726, HAMPDEN, ME, 04444-0726, US

(21) Appl. No.: 10/540,121

(22) PCT Filed: Nov. 20, 2003
(86) PCT No.: PCT/EP03/12983

§ 371 Date: Oct. 18, 2005

(30) Foreign Application Priority Data
Dec. 20, 2002 (DE) 102 61 176.9

(51) Int. Cl. B62D 11/02

(52) U.S. Cl. 180/6.2

(57) ABSTRACT

1. Method and device for assisting the driver of a vehicle during a parking maneuver. 2.1. Known devices for assisting the driver of a vehicle during the execution of a parking maneuver usually comprise surroundings-sensing means for sensing and measuring potential parking gaps, means for determining a parking strategy and information means for outputting instructions to the driver, which instructions guide him into the parking gap. The new method and the new device are intended to provide the driver with better assistance during the execution of the parking maneuver. 2.2. For this purpose, a parking situation image on which the parking gap, an optimum setpoint position and a first and second vehicle are represented in a plan view is displayed to the driver on an image display device. In this context, the optimum setpoint position corresponds to a position which the vehicle is intended to assume within the parking gap, the first vehicle corresponds to the vehicle in its instantaneous position and the second vehicle corresponds to the vehicle in an expected target position which can be varied by means of the steering angle.

The invention relates to a method and a device for assisting the driver of a vehicle during a parking maneuver according to the preamble of patent claims 1 and 22, respectively.

A method of the generic type is known, for example, from DE 38 13 083 C3. In this method, the driver of a vehicle is assisted during the execution of a parking maneuver in that a potential parking gap is determined and measured using surroundings-sensing means arranged on the vehicle, in that, furthermore, a setpoint trajectory along which the vehicle is to be moved during the parking maneuver is determined as a function of the dimensions of the parking gap, and in that the driver is requested, by means of a display device, to move the steering wheel into a position which permits parking in accordance with the setpoint trajectory.

DE 198 09 416 A1 also discloses that a parking strategy is determined as a function of the dimensions of the parking gap and that the driver is requested by means of a visual display device, an acoustic voice output unit or a haptic steering wheel, to perform specific actions by means of which he is guided into the parking gap in accordance with the determined parking strategy.

It is disadvantageous here that the instructions to the driver are not very intuitive. In particular it is impossible for the driver to assess the path along which he is being guided into the parking gap and to assess what influence a deviation, albeit only a small one, from the instructions would have.

The invention is based on the object of specifying a method which provides the driver with better assistance during the execution of the parking maneuver. The invention is also based on the object of specifying a device for executing the method.

The object is achieved according to the invention by means of the features of Patent claims 1 and 22, respectively. Advantageous refinements and developments emerge from the subclaims.

According to the invention, a parking gap is sensed and measured from the vehicle, a setpoint trajectory along which the vehicle is to be moved during the parking maneuver is determined in accordance with a predefined parking strategy, and a parking situation image on which the driver can perceive how he is being guided into the parking gap is displayed to the driver on an image display device. For this purpose, the parking situation image shows, in a plan view, the parking gap, an optimum setpoint position as well as a first vehicle and a second vehicle and preferably also the setpoint trajectory. In this context, the optimum setpoint position corresponds here to a position which the vehicle is intended to adopt within the parking gap, the first vehicle corresponds to the vehicle in its instantaneous position and the second vehicle corresponds to the vehicle in a target position which the vehicle is expected to adopt when it is moved along the setpoint trajectory.

The setpoint trajectory is preferably determined as a function of the initial steering angle, i.e. as function of the steering wheel position at the time when the parking maneuver starts.

The setpoint trajectory is preferably determined here in such a way that it starts at a starting point with a section which can be traveled through with a constant steering angle, with this constant steering angle corresponding to the steering angle which is set at the starting point at the starting time.

The setpoint trajectory is preferably also determined in such a way that a second section which can also be traveled through with a constant steering angle adjoins the first section.

The parking gap is advantageously sensed and measured while the vehicle is traveling past it, and the driver is requested to move back if he has traveled past the starting point of the setpoint trajectory. If the vehicle has then reached the starting position, it is advantageously automatically stopped.

In one advantageous development of the method, when the vehicle is stationary the driver is requested to turn the steering wheel. As a result, the position of the second vehicle and the profile of the setpoint trajectory are varied. The driver is preferably requested to move the second vehicle into the optimum setpoint position by turning the steering wheel. The direction of rotation of the steering wheel is preferably indicated to the driver in a visual and/or acoustic and/or haptic fashion.

Feedback is preferably output to the driver if the second vehicle has reached the optimum setpoint position. The feedback is advantageously provided by changing the color of the second vehicle which is shown in the parking situation image, for example by changing the color of the second vehicle from red to green.

As soon as the driver has moved the second vehicle into the optimum setpoint position, he is requested to drive off with the steering wheel held in position.

The parking situation image is preferably removed from the display when the vehicle is driven off and is advantageously displayed again whenever it is stopped or braked.

In one advantageous development of the method the vehicle is automatically stopped if the end of a section of the setpoint trajectory which can be traveled through with a constant steering angle is reached during the execution of the parking maneuver.

In a further advantageous development of the method the position of the vehicle during the execution of the parking maneuver is continuously determined and the vehicle is automatically stopped if it leaves a tolerance range defined around the setpoint trajectory. A departure from the tolerance range is preferably indicated to the driver here in a visual and/or acoustic and/or haptic fashion.

The setpoint trajectory is preferably newly calculated whenever the vehicle is stopped, in order to prevent the driver having to make adjustments to the original setpoint trajectory.

In a further advantageous development of the method, the driver is informed whether it is necessary to maneuver the vehicle, i.e. to change the direction of travel, in order to reach the final parking position.

A device for carrying out the method according to the invention comprises surroundings-sensing means for sensing and measuring a parking gap which is located in the surroundings of the vehicle, evaluation means for determining the setpoint trajectory along which the vehicle is to be moved during the parking maneuver, information means for informing the driver about the driver actions necessary to execute the parking maneuver, and position sensing means for determining the position of the vehicle, with the information means comprising an image display device on which the parking situation image with the parking gap, the optimum setpoint position, the setpoint trajectory as well as the first vehicle and the second vehicle can be represented in a plan view.

The essential advantage of the method according to the invention and the device according to the invention is that the driver intuitively recognizes how the parking maneuver is to be executed, in particular he perceives the position of the optimum setpoint position. Furthermore he readily perceives the influence which he has on the correct execution of the parking maneuver.

The invention is explained in more detail below with reference to figures, in which:

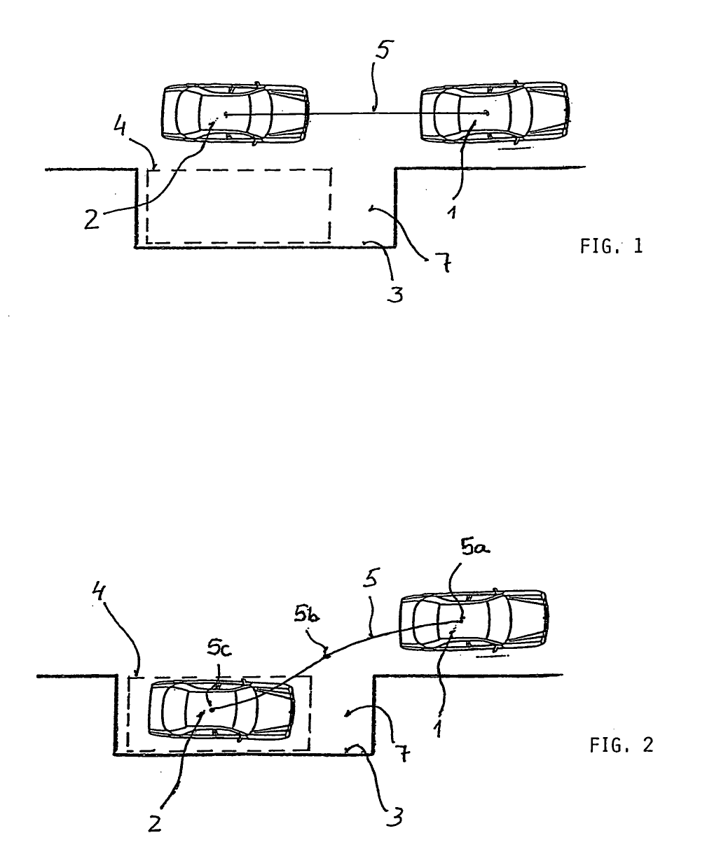

FIG. 1 shows a first parking situation image,

FIG. 2 shows a second parking situation image,

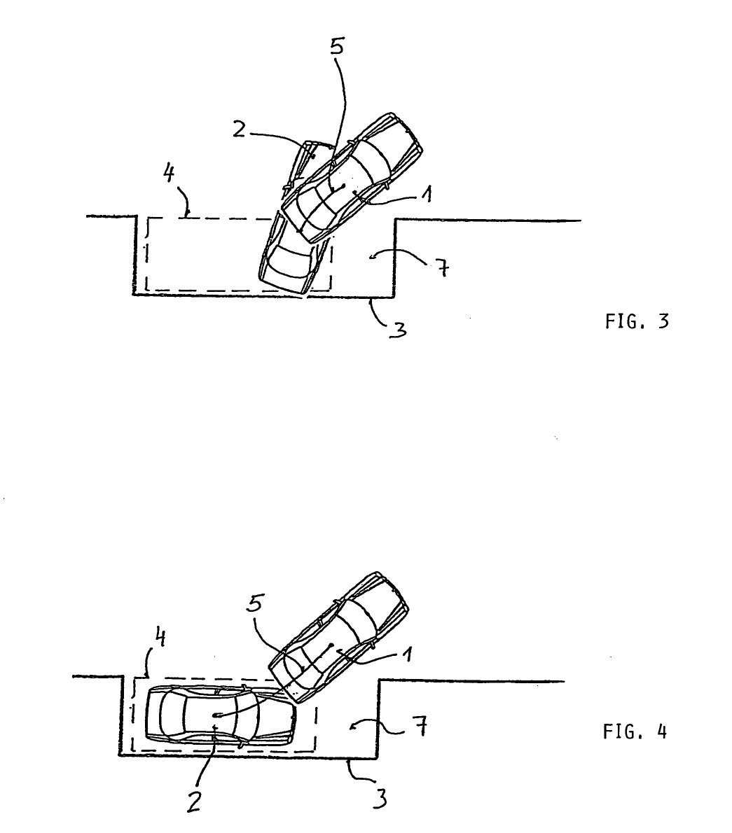

FIG. 3 shows a third parking situation image,

FIG. 4 shows a fourth parking situation image,

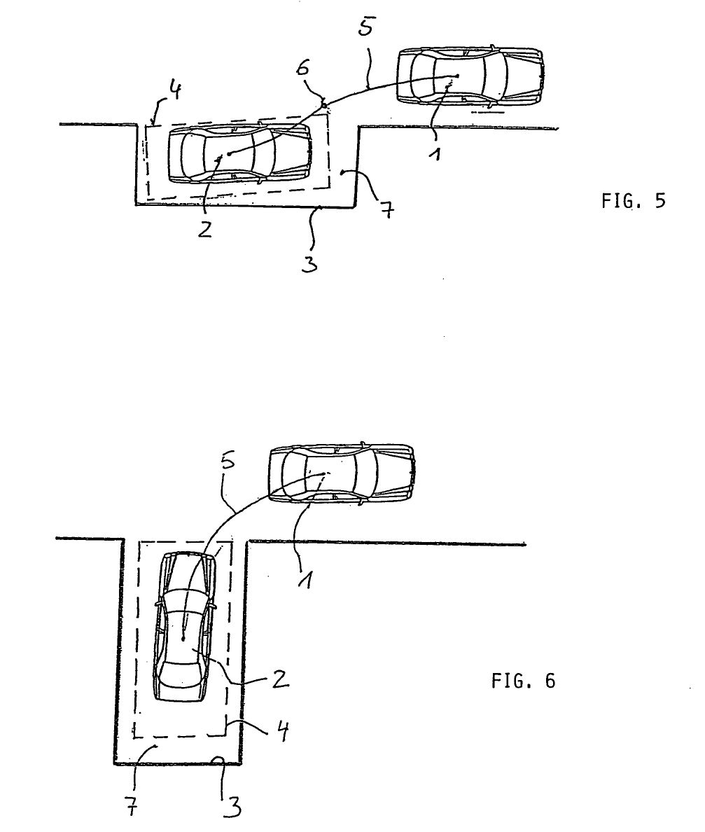

FIG. 5 shows a fifth parking situation image, and

FIG. 6 shows a sixth parking situation image.

The device according to the invention for assisting the driver of a vehicle during the execution of a parking maneuver has surroundings-sensing means, position sensing means, evaluation means and information means.

The surroundings-sensing means are arranged on the vehicle. They are used to sense and measure a parking gap in the region to the side of the vehicle while the vehicle is traveling past the parking gap. The sensing and measurement of the parking gap is based here on the detection of objects from the surroundings of the vehicle and the determination of the distance from these objects. The surroundings-sensing means comprise for this purpose distance sensors which can be implemented in a known fashion, for example as ultrasonic sensors, radar sensors or laser sensors.

With the position sensing means the position of the vehicle relative to the parking gap and thus the movement path of the vehicle is determined. They can comprise, in a known fashion, for example wheel sensors for determining the wheel speed and steering wheel sensors for determining the steering direction. However, the sensing of positions can also be based on a GPS system.

Since the parking gap moves relative to the vehicle in accordance with the movement of the vehicle it is also conceivable to determine the movement path by evaluating the change in the position of the parking gap.

The evaluation means are used to check whether the parking gap is sufficiently large for a successful parking maneuver. If this is the case, an optimum setpoint position into which the vehicle can be moved during the parking maneuver is determined.

The information means inform the driver about the steps necessary to execute the parking maneuver. The information means comprise an image display device which is arranged in the vehicle, for example on the dashboard and on which the parking situation is displayed schematically as a plan view in the form of a parking situation image. Furthermore, sound or voice output means or a haptic steering wheel may be provided as information means in the vehicle.

The method according to the invention will be described below for the case in which the vehicle is to be parked laterally, in the direction of travel. The parking strategy provides in this case for the driver to be guided into the parking gap by traveling in reverse on an s-shaped setpoint trajectory which is composed of two circular sections which can be traveled through with a constant steering angle.

As already stated, the parking gap is measured using the surroundings-sensing means as the vehicle travels past. If the parking gap is large enough, the driver can be requested to stop by the information means. It is also conceivable to stop the vehicle automatically if this is desired by the driver and he has previously communicated his desire to the device by means of a corresponding action.

When the vehicle is stationary it is then tested whether the vehicle is in a starting position from which parking along a setpoint trajectory composed of two circular sections is possible. If the vehicle is moved beyond the starting position, the driver is requested to move back by the information means. The request may be made here in a visual, acoustic or haptic fashion. If the driver has then moved back far enough, the vehicle is automatically stopped in the starting position or the driver is requested to stop.

In the starting position, the parking situation image which is shown as an example in FIG. 1 is displayed to the driver on the image display device. The parking situation image is a schematic representation here of the parking situation at the start of the parking maneuver.

The parking gap 7 is represented with its boundaries 3 on the parking situation image. An optimum setpoint position 4 which the vehicle is intended to adopt within the parking gap 7 is displayed within the parking gap 7 by means of a square region. Furthermore, a first vehicle 1 and a second vehicle 2 are represented on the parking situation image, with the first vehicle 1 corresponding to the vehicle in its instantaneous position, and the second vehicle 2 corresponding to the vehicle in an expected target position. The expected target position is here a position which is dependent on the steering angle and which the vehicle is expected to adopt if it moves along the setpoint trajectory 5. The setpoint trajectory 5 is also represented on the parking situation image. It is predefined in such a way that it is composed of two sections which can each be traveled through with a constant steering angle. The radius of the first section is predefined here in accordance with the instantaneous steering angle which is set. In the illustrated example there is no steering wheel lock and the setpoint trajectory 5 is therefore a straight line.

The parking gap 7, the optimum setpoint position 4 and the first vehicle 1 are static image elements of the parking situation image while, on the other hand, the second vehicle 2 is a moving image element whose position can be varied by the driver by turning the steering wheel. The setpoint trajectory 5 along which the vehicle is intended to move out of the starting position corresponding to the first vehicle 1 into the target position corresponding to the second vehicle 2 also varies in accordance with the movement of the steering wheel.

The driver is then requested by the information means to turn the steering wheel. This request may be made in a visual form, for example by means of a display on the image display device, in an acoustic form, for example by means of a voice output, or in a haptic form, for example by means of a torque, applied to the steering wheel, in the desired steering direction or an amplified opposing torque in the wrong steering direction.

The task of the driver is then to turn the steering wheel, with the vehicle stationary, until the second vehicle 2 is located in the optimum setpoint position 4. If the driver has achieved this, a corresponding message is output to him, for example by the color of the second vehicle 2 changing from red to green.

FIG. 2 shows the parking situation image for the situation in which the driver has moved the second vehicle 2 into the optimum setpoint position 4. The driver is then requested to hold the steering wheel in the instantaneous position and to drive off. As soon as he drives off, the parking situation image is removed from the display. The removal from the display is intended to prevent the driver from being distracted by the parking situation image and attempting to correct the steering angle. Likewise, all the acoustic, visual and haptic messages which had requested the driver to perform a steering operation are removed from the display.

When the parking situation image is removed from the display, the image display device is available for displaying other information. For example, an obstacle image on which the vehicle and the distance between the vehicle and the potential obstacles are indicated can then be displayed.

During the travel, the position of the vehicle is continuously checked with the position sensing means. If the vehicle then reaches the turning point 5b, i.e. the end of the first circular section of the setpoint trajectory 5, the vehicle is automatically stopped or the driver is requested to stop.

When the vehicle stops, the parking situation image is displayed again. In this case, the current parking situation image with the instantaneous position of the vehicle as a new starting position is represented, as shown in FIG. 3.

The driver is then requested to move the second vehicle 2 into the optimum setpoint position 4 by steering. When he has done this, as illustrated in FIG. 4, he is requested to drive off with the steering wheel held in position. The setpoint trajectory 5 shown in FIG. 3 is then composed only of a circular section. The latter corresponds to the second circular section of the setpoint trajectory 5 from FIG. 2. The driver is then guided into the optimum setpoint position 4 by means of this section.

As soon as the driver drives off, all the messages which have requested him to perform a steering operation and the parking situation image are removed from the display again. If the vehicle then reaches the end of the setpoint trajectory 5, it is automatically stopped or the driver is requested to stop. Furthermore the driver is informed in a visual, acoustic or haptic fashion, that the parking assistance is now ended.

The method has previously been described for the situation in which the driver is following the instructions correctly. However, if the driver steers incorrectly, it may no longer be possible to park in the optimum setpoint position 4 without additional maneuvering, i.e. without additionally changing the direction of travel.

In order to prevent such errors in good time, the actual position of the vehicle is continuously compared with the setpoint trajectory 5 during travel. If it is to be expected that the driver will steer so incorrectly that the optimum setpoint position 4 can no longer be reached without additional maneuvering, which is the case if the vehicle leaves a tolerance range defined around the setpoint trajectory 5, the vehicle is stopped and the driver is requested, by means of acoustic, visual or haptic messages, to correct the steering movement. When the vehicle stops, the parking situation image with the current parking situation and the current position of the vehicle are displayed as a new starting position to the driver. The setpoint trajectory is newly calculated on the basis of the new starting position in order to prevent the driver having to make adjustments in order to place the vehicle on the original setpoint trajectory.

It is also conceivable for means for correcting the steering angle to be provided in the vehicle, said means permitting, within certain limits, automatic correction of the steering angle and thus automatic correction of steering errors.

In order to permit a reaction in good time, the speed of the vehicle is advantageously limited during travel to a value range lying below a predefined maximum value.

In the example shown in FIGS. 1 to 4, the parking gap 7 is sufficiently large in order to permit parking along the road without maneuvering. If the size of the parking gap only permits parking with maneuvering, this is communicated to the driver. The optimum setpoint position is then no longer represented parallel to the road in the parking situation image, as shown in FIG. 5, but rather in an oblique position, which is a sign to the driver that this position is not the end position but instead can still be corrected by a maneuver. In addition, the subsequent maneuvering direction can be displayed to the driver, by means of an arrow for example.

In the example illustrated until now, the driver is assisted when parking in reverse into a parking gap extending in the direction of travel. Of course, the method can also be modified for a parking strategy which provides for parking in reverse into a parking gap which extends transversely with respect to the direction of travel. In this case, the setpoint trajectory 5 is composed, as illustrated in FIG. 6, of a single circular section so that it is no longer necessary to stop and perform a steering operation during the parking maneuver. The assistance to the driver is provided in a way analogous to the assistance offered to the driver when he parks in a parking gap extending in the direction of travel. Of course, it is also possible to provide for a maneuver in this context.

If the assistance can be carried out according to a plurality of parking strategies, the driver selects the desired parking strategy using corresponding input means and he therefore specifies whether the vehicle is to be parked in the direction of travel or transversely with respect to the direction of travel and whether the parking gap is located on the left-hand side or right-hand side of the vehicle. However, it is also conceivable for the device to make this decision itself taking into account the dimensions of the parking gap or to request the driver to select one of a plurality of possible parking strategies.

1. A method for assisting the driver of a vehicle during a parking maneuver, wherein a parking gap is sensed and measured from the vehicle and a setpoint trajectory (5) along which the vehicle is to be moved during the parking maneuver is determined in accordance with a predefined parking strategy, characterized in that a parking situation image on which the parking gap (7), an optimum setpoint position (4) as well as a first vehicle (1) and a second vehicle (2) are represented in a plan view is displayed to the driver on an image display device, wherein the optimum setpoint position (4) corresponds to a position which the vehicle is intended to adopt within the parking gap (7), the first vehicle (1) corresponds to the vehicle in its instantaneous position and the second vehicle (2) corresponds to the vehicle in a target position (2) which the vehicle is expected to adopt when it is moved along the setpoint trajectory (5).

2. The method as claimed in claim 1, characterized in that the setpoint trajectory (5) is determined as a function of the initial steering angle.

3-21. (canceled)

22. A device for assisting the driver of a vehicle during a parking maneuver, having surroundings-sensing means for sensing and measuring a parking gap in the surroundings of the vehicle, having evaluation means for determining a setpoint trajectory (5) along which the vehicle is to be moved during the parking maneuver, having information means for informing the driver about the driver actions necessary to execute the parking maneuver, and having position sensing means for determining the position of the vehicle, characterized in that the information means comprise an image display device for displaying a parking situation image on which the parking gap (7), an optimum setpoint position (4) which can be reached by the vehicle within the parking gap (7), the setpoint trajectory (5) as well as a first vehicle (1) corresponding to the vehicle in its instantaneous position and a second vehicle (2) corresponding to the vehicle in a target position which it is expected to reach can be represented in a plan view.

23. The method as claimed in claim 1, characterized in that the setpoint trajectory (5) is determined in such a way that it has a first section which starts at a starting point (5a) and can be traveled through with a constant steering angle and whose profile is predefined by the steering angle which is set at the starting point (5a).

24. The method as claimed in claim 23, characterized in that the setpoint trajectory (5) is determined in such a way that a second section which can be traveled through with a constant steering angle adjoins the first section.

25. The method as claimed in claim 1, characterized in that the setpoint trajectory (5) is represented on the parking situation image.

26. The method as claimed in claim 1, characterized in that the parking gap (7) is determined and measured while the vehicle is traveling past the parking gap, and in that the driver is requested to move back if he has traveled past the starting point of the setpoint trajectory.

27. The method as claimed in claim 26, characterized in that the vehicle is automatically stopped if it has reached the starting position (5a).

28. The method as claimed in claim 1, characterized in that when the vehicle is stationary the driver is requested to turn the steering wheel.

29. The method as claimed in claim 28, characterized in that the driver is requested to move the second vehicle (2) shown in the parking situation image into the optimum setpoint position (4) by turning the steering wheel.

30. The method as claimed in claim 28, characterized in that the direction of rotation of the steering wheel is indicated to the driver in a visual and/or acoustic and/or haptic fashion.

31. The method as claimed in claim 1, characterized in that feedback is output to the driver if the second vehicle (2) has reached the optimum setpoint position (4).

32. The method as claimed in claim 31, characterized in that the feedback is given by changing the color of an image element which represents the second vehicle (2).

33. The method as claimed in claim 1, characterized in that the driver is requested to drive off with the steering wheel held in position if the second vehicle (2) is in the optimum setpoint position (4).

34. The method as claimed in claim 1, characterized in that the parking situation image is removed from the display when the vehicle is driven off.

35. The method as claimed in claim 27, characterized in that the parking situation image is displayed when the vehicle is stopped or braked.

36. The method as claimed in claim 1, characterized in that the vehicle is automatically stopped if the end (5b, 5c) of a section of the setpoint trajectory (5) which can be traveled through with a constant steering angle is reached during the execution of the parking maneuver.

37. The method as claimed in claim 1, characterized in that the position of the vehicle during the execution of the parking maneuver is determined and in that the vehicle is automatically stopped if it leaves a tolerance range defined around the setpoint trajectory (5).

38. The method as claimed in claim 37, characterized in that a departure from the tolerance range (8) is indicated to the driver in a visual and/or acoustic and/or haptic fashion.

39. The method as claimed in claim 1, characterized in that the setpoint trajectory (5) is newly calculated if the vehicle is stopped during the execution of the parking maneuver.

40. The method as claimed in claim 1, characterized in that the driver is informed whether it is necessary to maneuver the vehicle in order to reach the final parking position.

41. The method as claimed in claim 1, characterized in that the speed of the vehicle during the execution of the parking maneuver is limited to a value range lying below a predefined maximum value.
